(19) United States
(12) Patent Application Publication
(10) Pub. No.: US 2014/0153835 A1
(43) Pub. Date: Jun. 5, 2014

(54) GEOSPATIAL-CURVE-BASED GEOLOCATION OF MEDIA ITEMS

(71) Applicant: Samuel Wye PRITT, Walkersville, MD (US)

(72) Inventor: Samuel Wye PRITT, Walkersville, MD (US)

(21) Appl. No.: 13/923,814

(22) Filed: Jun. 21, 2013

Related U.S. Application Data
(60) Provisional application No. 61/732,053, filed on Nov. 30, 2012.

(51) Int. Cl. G06K 9/62

(52) U.S. Cl. CPC G06K 9/6202
USPC 382/203

(57) ABSTRACT

Approaches to facilitating geospatial-curve-based geolocation of media items are provided. In certain implementations, one or more model curves may be generated based on modeling information associated with one or more locations. A geospatial curve associated with a geographic media item may be transformed based on one or more criteria. The one or more criteria may, for example, include a width of the geospatial curve, an angular size associated with a measuring unit of the one or more model curves, a focal length associated with the geographic media item, or other criteria. The transformed geospatial curve may be a non-polygonal geospatial curve. The transformed geospatial curve may be compared with one or more segments of the one or more model curves. Location information associated with the geographic media item may be determined based on the comparison of the transformed geospatial curve with the one or more segments.

### RELATED APPLICATIONS

This application claims priority from U.S. Provisional Patent Application No. 61/732,053, filed Nov. 30, 2012, and entitled “GEOSPATIAL-CURVE-BASED GEOLOCATION OF MEDIA ITEMS,” which is hereby incorporated by reference herein in its entirety.

### FIELD OF THE DISCLOSURE

This disclosure relates generally to geolocation of media items, including, among other geolocation approaches, geospatial-curve-based geolocation of media items.

### BACKGROUND

Geolocation of media items, such as photographs, videos, or other media items, may refer to the processing of determining where a media item was captured. Geolocation of media items may be important in counterterrorism, photo tourism, community remote sensing, robot navigation, or other scenarios. With respect to photographs, typical geolocation approaches involve matching photographs against a database of already geolocated photographs. However, while matching of photographs may be successful for geolocation of photographs taken in populous urban areas for which large collections of geotagged photographs exist, such typical approaches have limited success in other areas (e.g., rural areas, urban areas for which large collections of geotagged photographs do not exist, etc.). These and other drawbacks exist.

### SUMMARY

One aspect of the disclosure relates to a system configured to facilitate geospatial-curve-based geolocation of media items, in accordance with one or more implementations. In exemplary implementations, one or more panoramic model curves may be generated based on modeling information associated with one or more locations. A geospatial curve may be extracted from a geographic media item. The geospatial curve may be transformed based on one or more criteria. The transformed geospatial curve may be compared with one or more segments of the one or more panoramic model curves. Location information associated with the geographic media item may be determined based on the comparison of the transformed geospatial curve with the one or more segments of the one or more panoramic model curves. In this way, among other benefits, photographs, videos, or other media items may be geolocated without necessarily relying on the availability of large collections of geotagged media items. Geospatial-curve-based geolocation of media items may, for example, be utilized in counterterrorism strategies (e.g., determining locations of terrorist groups by geolocating their photographs and videos based on the horizons in the photographs and videos), land cover analysis, glacier monitoring, invasive plan species tracking, photo tourism, robot navigation, or other scenarios.

In some implementations, the system may include one or more servers. The server(s) may be configured to communicate with one or more client computing platforms according to a client/server architecture. The users may access the system via the client computing platforms.

The server(s) may be configured to execute one or more computer program modules to facilitate geospatial-curve-based geolocation of media items. The computer program modules may include one or more of a curve generation module, a curve transformation module, a comparison module, a location module, and/or other modules. In some implementations, the client computing platforms may be configured to execute one or more computer program modules that are the same as or similar to the computer program modules of the server(s) to facilitate geospatial-curve-based geolocation of media items.

The curve generation module may be configured to generate one or more model curves based on modeling information associated with one or more locations. In certain implementations, the modeling information may include elevation information, boundary information, or a combination thereof associated with the one or more locations. In one or more implementations, the one or more model curves may include one or more panoramic model curves corresponding to one or more 360-degree views. Each of the model curves may, for example, correspond to one of the locations associated with the modeling information.

In some implementations, the curve generation module may be configured such that generation of the one or more model curves may comprise projecting points associated with the modeling information onto one or more cylindrical image planes.

The curve transformation module may be configured to transform a geospatial curve associated with a geographic media item based on one or more criteria. In certain implementations, the one or more criteria includes a width of the geospatial curve, an angular size associated with a measuring unit of the one or more model curves, a focal length associated with the geographic media item, or other criteria. In some implementations, the geospatial curve may include a horizon curve, a hydrographic curve, man-made pathways, geographic boundary curves, urban skyline curves, or other curves associated with the geographic media item.

The comparison module may be configured to compare the transformed geospatial curve with one or more segments of the one or more model curves. As indicated, in certain implementations, the one or more model curves may include one or more panoramic model curves corresponding to one or more 360-degree views. The one or more segments of the one or more model curves may correspond to one or more less-than-360-degree portions of the one or more 360-degree views. The geospatial curve associated with the geographic media item may correspond to a less-than-360-degree view. The location module may be configured to determine location information associated with the geographic media item based on the comparison of the transformed geospatial curve with the one or more segments of the one or more model curves.

In some implementations, the comparison module may be configured such that the comparison of the transformed geospatial curve with the one or more segments of the one or more model curves may comprise determining one or more areas between the transformed geospatial curve and the one or more segments. In one or more implementations, the determination of the one or more areas may comprise rotating, shifting, or a combination thereof the transformed geospatial curve, the one or more segments, or a combination thereof. The determination of the location information associated with the geographic media item by the location module may be based on the one or more determined areas.

In certain implementations, the curve generation module may generate one or more model curves based on modeling information associated with one or more locations. The curve transformation module may transform the one or more model curves based on one or more criteria. The one or more criteria may include a width of a geospatial curve associated with a geographic media item, an angular size associated with a measuring unit of the one or more model curves, a focal length associated with the geographic media item, or other criteria. The comparison module may be configured to compare a non-polygonal geospatial curve associated with a geographic media item with one or more segments of the one or more transformed model curves. The location module may be configured to determine location information associated with the geographic media item based on the comparison of the non-polygonal geospatial curve with the one or more segments.

In some implementations, the comparison module may be configured such that the comparison of the non-polygonal geospatial curve with the one or more segments of the one or more transformed model curves may comprise determining one or more areas between the geospatial curve and the one or more segments. In one or more implementations, the determination of the one or more areas may comprise rotating, shifting, or a combination thereof the non-polygonal geospatial curve, the one or more segments, or a combination thereof. The determination of the location information associated with the geographic media item by the location module may be based on the one or more determined areas.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a system configured to facilitate geospatial-curve-based geolocation of media items, in accordance with one or more implementations.

FIG. 2 illustrates a diagram of a model curve generated based on modeling information associated with one or more locations, in accordance with one or more implementations.

FIGS. 3A, 3B, and 3C illustrate diagrams of a photograph, a geospatial curve associated with the photograph, and a transformed geospatial curve associated with the photograph, in accordance with one or more implementations.

FIG. 4 illustrates a diagram of model curve segments, in accordance with one or more implementations.

FIG. 5 illustrates a comparison of a geospatial curve with a model curve segment, in accordance with one or more implementations.

FIGS. 6 and 7 illustrate methods of facilitating geospatial-curve-based geolocation of media items, in accordance with one or more implementations.

### DETAILED DESCRIPTION

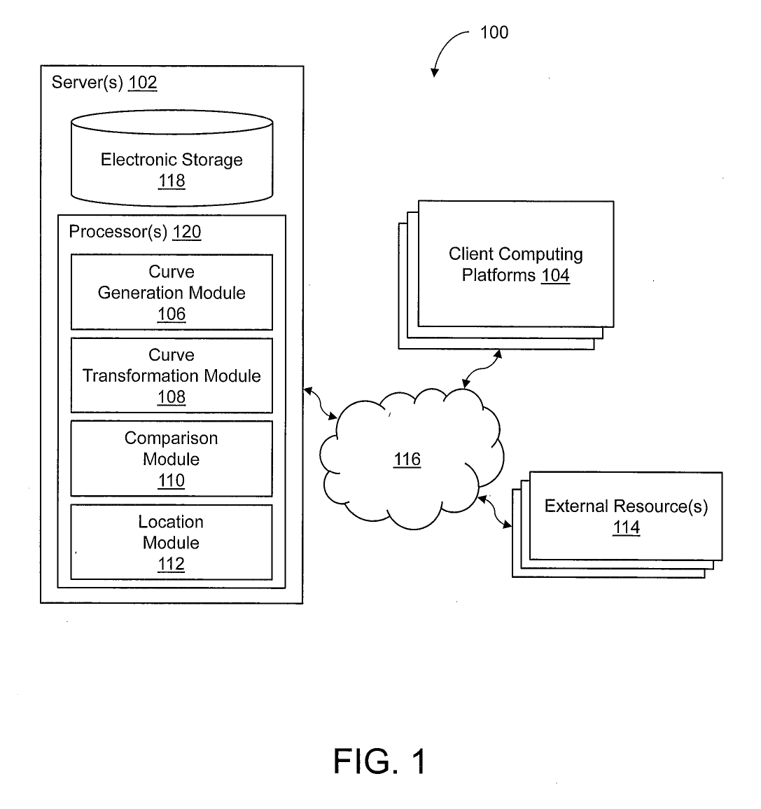

FIG. 1 illustrates a system 100 configured to facilitate geospatial-curve-based geolocation of media items, in accordance with one or more implementations. In exemplary implementations, one or more panoramic model curves may be generated based on modeling information associated with one or more locations. A geospatial curve may be extracted from a geographic media item. The geospatial curve may be transformed based on a width of the extracted geospatial curve, an angular size associated with a measuring unit of the one or more panoramic model curves, a focal length associated with the geographic media item, or other criteria. The transformed geospatial curve may be compared with one or more segments of the one or more panoramic model curves. Location information associated with the geographic media item may be determined based on the comparison of the transformed geospatial curve with the one or more segments of the one or more panoramic model curves. In this way, among other benefits, photographs, videos, or other media items may be geolocated without necessarily relying on the availability of large collections of geotagged media items.

In some implementations, system 100 may include one or more servers 102. Server(s) 102 may be configured to communicate with one or more client computing platforms 104 according to a client/server architecture. The users may access system 100 via client computing platforms 104.

Server(s) 102 may be configured to execute one or more computer program modules to facilitate geospatial-curve-based geolocation of media items. The computer program modules may include one or more of a curve generation module 106, a curve transformation module 108, a comparison module 110, a location module 112, and/or other modules. In some implementations, client computing platforms 104 may be configured to execute one or more computer program modules that are the same as or similar to the computer program modules of server(s) 102 to facilitate geospatial-curve-based geolocation of media items.

Curve generation module 106 may be configured to generate one or more model curves based on modeling information associated with one or more locations. In certain implementations, the modeling information may include elevation information, boundary information, or a combination thereof associated with the one or more locations. In one or more implementations, the one or more model curves may include one or more panoramic model curves corresponding to one or more 360-degree views. Each of the model curves may, for example, correspond to one of the locations associated with the modeling information.

By way of example, digital elevation models (DEM) that includes terrain elevation data for geographic areas around the world may be utilized to generate 360° panoramic horizon model curves or other model curves. These panoramic horizon model curves may be stored for subsequent comparisons with horizon curves rendered on media items to determine a location associated with the media items. Because the direction that a real-world camera or other capturing device is facing when a media item is taken (by the real-world camera or other capturing device) may initially be unknown, panoramic model curves may be utilized to avoid or otherwise reduce the need for the direction information. One or more panoramic horizon model curves may be generated for each sample point on the DEM where each sample point corresponds to a location associated with the DEM. The sampling of the points may, for example, reflect locations that are a predetermined distance apart (e.g., sampling every 500 meters, every 1000 meters, etc.). The distances between the sample points may be based on desired execution time, desired accuracy, or other criteria (e.g., greater distances between the sample points may result in faster execution time, smaller distances between the sample points may result in better accuracy, etc.)

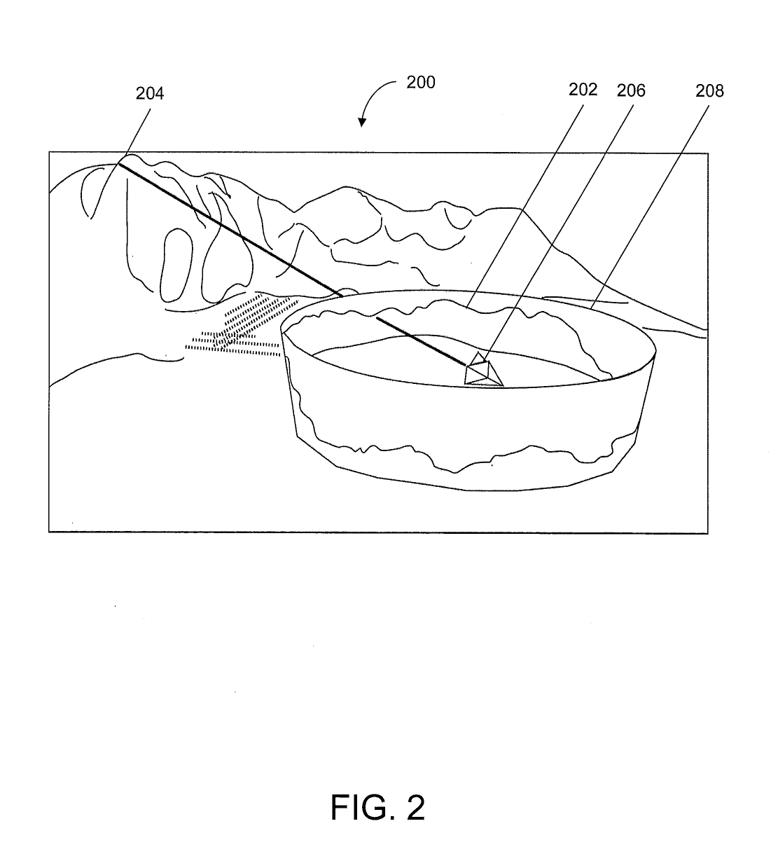

In some implementations, curve generation module 106 may be configured such that generation of the one or more model curves may comprise projecting points associated with the modeling information onto one or more cylindrical image planes. For example, as shown by FIG. 2, diagram 200 illustrate a panoramic model curve 202 that may be generated by projecting points 204 from the DEM to a virtual panoramic camera 206, varying the spacing of the projected points (e.g., points along panoramic curve 202) based on their distance to the virtual panoramic camera 206 so that nearer points 204 are projected more densely than distant points 204, and saving the upper convex hull of the projected points. The projection (from which the panoramic model curve 202 is based) may, for example, be based on the following equations: x′=arc tan [(y−y₀)/(x−x₀)]/dθ; y′=−F·(z−z₀)/r+y_{c}. As an example, x and y may be the easting and northing coordinates of a given point 204 on the DEM; z may be an elevation of the projection; x′ and y′ may be the virtual camera pixel coordinates onto which the point 204 projects; x₀, y₀, and z₀ may be the coordinates of the virtual camera location on the DEM; dθ may be an angular width of one pixel on the projected panoramic horizon; r may be the distance from the virtual camera to the point 204 being projected; and y_{c} may be the vertical center of the virtual panoramic image plane 208 (e.g., half the height); and F may be a focal length of a real-world camera.

Curve transformation module 108 may be configured to transform a geospatial curve associated with a geographic media item based on one or more criteria. In certain implementations, the one or more criteria includes a width of the geospatial curve, an angular size associated with a measuring unit of the one or more model curves, a focal length associated with the geographic media item, or other criteria. In some implementations, the geospatial curve may include a horizon curve, a hydrographic curve (e.g., streams, rivers, lakes, shorelines, etc.), man-made pathways (e.g., highways, roads, railroads, etc.), geographic boundary curves (e.g., boundaries between different types of land cover), urban skyline curves, or other curves associated with the geographic media item. The one or more model curves may include one or more of horizon model curves, hydrographic model curves, geographic boundary model curves, model pathways, geographic boundary model curves, urban skyline model curves, or other model curves.

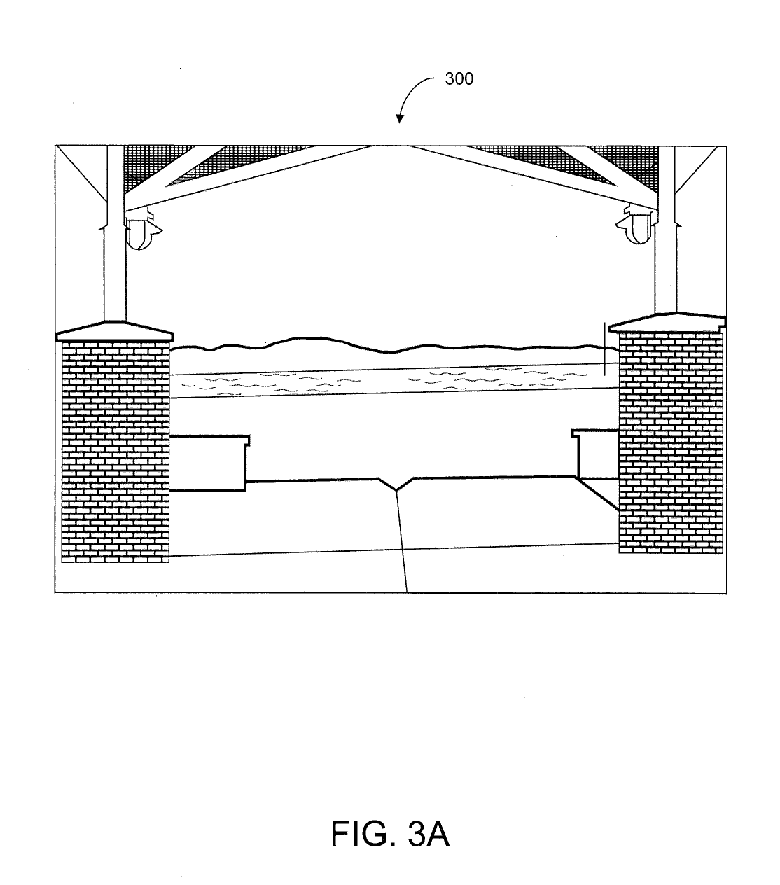

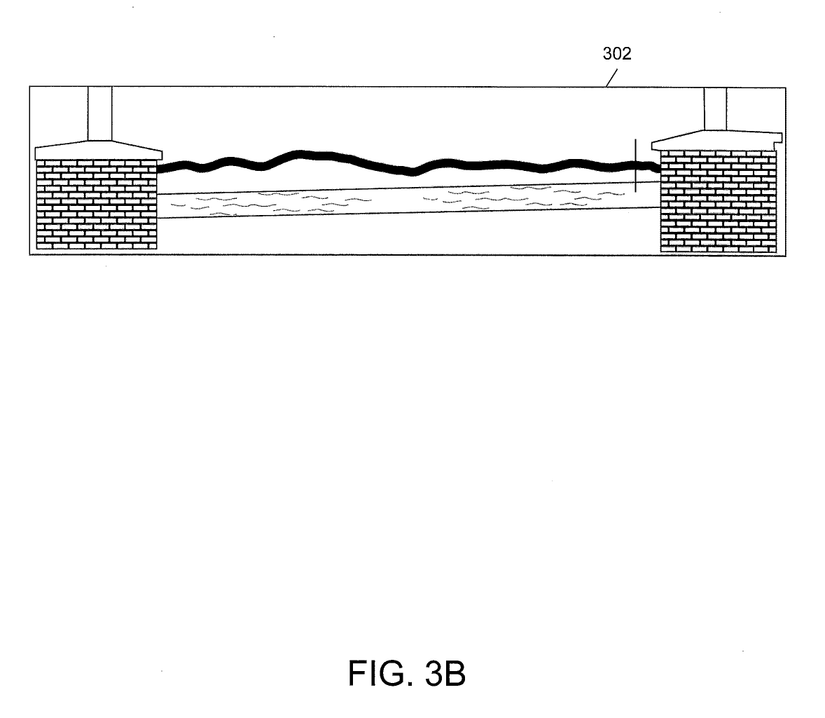

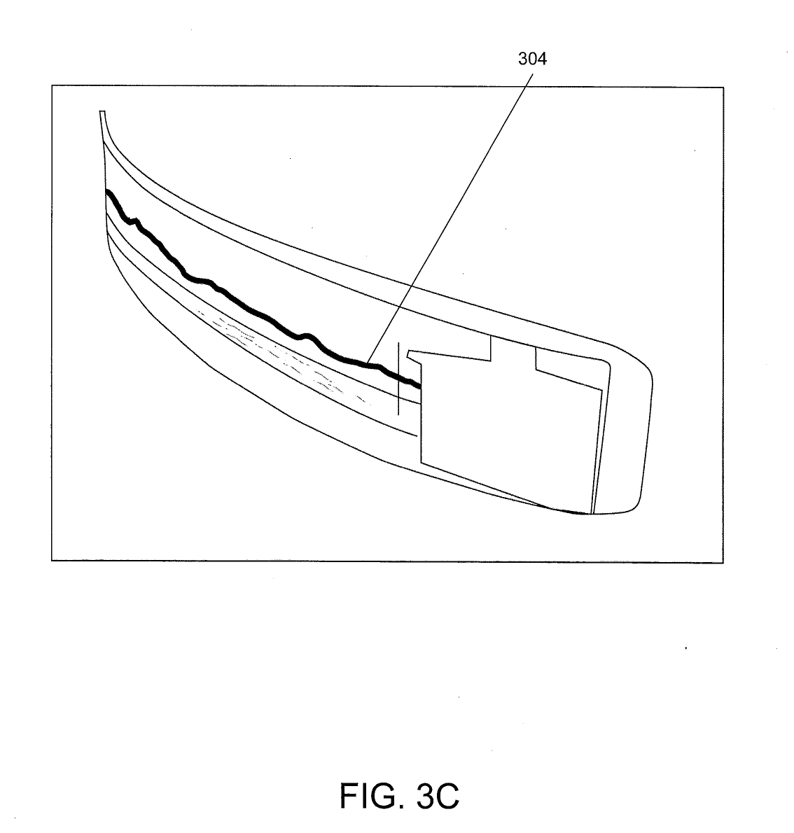

In one scenario, with respect to FIGS. 3A, 3B, and 3C, a photograph 300 may be processed to extract a geospatial curve 302 (e.g., a horizon curve) from photograph 300. The extracted geospatial curve 302 may then be transformed to account for the geometry of the model curves (e.g., panoramic horizon model curves derived from the DEM), for example, using the function h(x)=F·tan(xθ), where F may be a focal length of a real-world camera in pixels and θ is an angular size of one pixel given by θ=tan⁻¹(1/F). The focal length may, for example, be determined using metadata associated with the photograph 300 (e.g., metadata may store the focal length or other information about the real-world camera that captured the photograph 300), a database of possible focal lengths of the real-world camera, etc. The transformation converts geospatial curve 302 to the panoramic geometry of the model curves. The transformed geospatial curve 304 may have a new width of W=2 tan⁻¹(w/2F), where w is a width of geospatial curve 302 before the transformation.

Comparison module 110 may be configured to compare the transformed geospatial curve with one or more segments of the one or more model curves. As indicated, in certain implementations, the one or more model curves may include one or more panoramic model curves corresponding to one or more 360-degree views. The one or more segments of the one or more model curves may correspond to one or more less-than-360-degree portions of the one or more 360-degree views. The geospatial curve associated with the geographic media item may correspond to a less-than-360-degree view. Location module 112 may be configured to determine location information associated with the geographic media item based on the comparison of the transformed geospatial curve with the one or more segments of the one or more model curves.

In some implementations, comparison module 110 may be configured such that the comparison of the transformed geospatial curve with the one or more segments of the one or more model curves may comprise determining one or more areas between the transformed geospatial curve and the one or more segments. In one or more implementations, the determination of the one or more areas may comprise rotating, shifting, or a combination thereof the transformed geospatial curve, the one or more segments, or a combination thereof. The determination of the location information associated with the geographic media item by location module 112 may be based on the one or more determined areas.

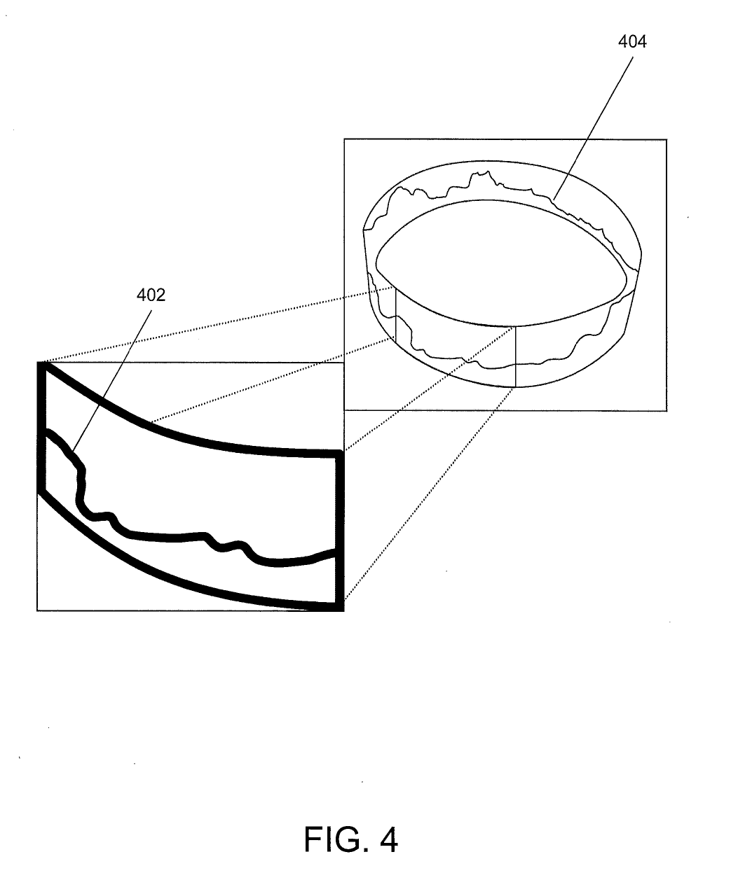

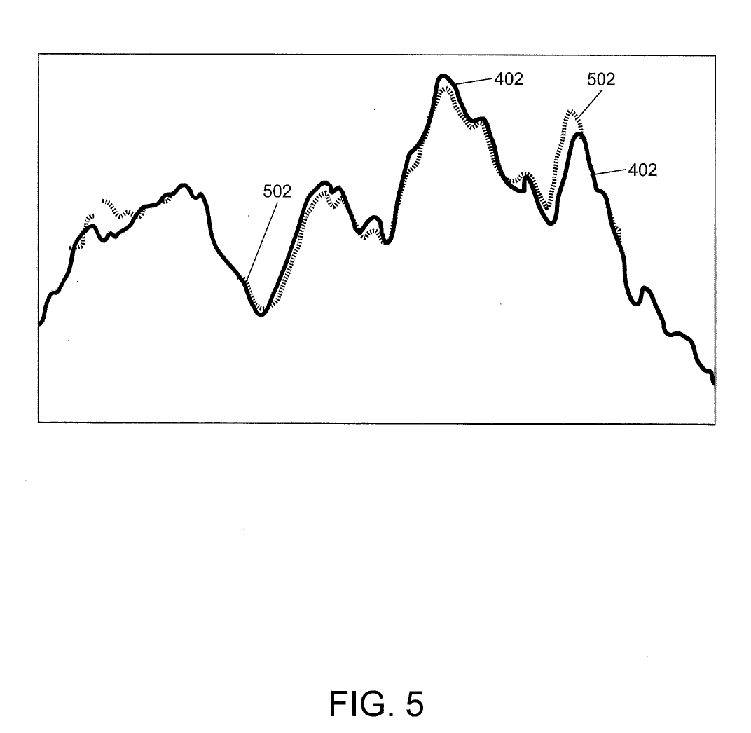

In one use case, as indicated by FIG. 4, one or more segments 402 may be extracted from one or more model curves 404 (e.g., panoramic horizon model curves derived from the DEM or other model curves). As indicated by FIG. 5, a transformed geospatial curve 502 of a photograph (e.g., photograph 300) may be compared against one or more segments (e.g., segments 402) of individuals ones of the model curves 404. The transformed geospatial curve 502 and a segment of a model curve 404 may be compared by rotating and shifting the curve 502 and the segment 402 of the model curve 404 vertically by the difference of their mean values, which aligns them on top of each other as shown by FIG. 5, and determining the area between them using the function: ∫|ƒ(x)−g(x)|dx). The area may indicate the amount of disparity between the transformed geospatial curve 502 of a photograph and the segment 402 of the model curve 404. The transformed geospatial curve 502 (e.g., the photo-derived horizon curve) may, for example, be compared with all of the segments of the model curve 404 (e.g., a DEM-derived horizon model curve) to account for every orientation (e.g., to the nearest angular degree) of the real-world camera that captured the photograph from which the photo-derived horizon curve is based. In this way, rolling (e.g., tilting) of the real-world camera may be accounted for as well as azimuth and elevation angles. In addition, among other advantages, a geospatial curve (e.g., a horizon curve) extracted from a photograph does not need to be a gapless geospatial curve. For example, foreground objects often obscure portions of a horizon, resulting in isolated horizon segments as shown by the black-white pattern curve (e.g., transformed geospatial curve 502) in FIG. 5.

The transformed geospatial curve 502 may be compared with segments 402 of each of the model curves 404 (e.g., DEM-derived horizon model curves) to determine the areas between the transformed geospatial curve 502 and the segments 402 of each of the model curves 404. As indicated, each of the model curves 404 may correspond to a location associated with the DEM. A model curve may, for example, be generated for each sample point on the DEM where each sample point corresponds to a location associated with the DEM. The sampling of the points may, for example, reflect locations that are a predetermined distance apart (e.g., sampling every 500 meters, every 1000 meters, etc.). Among the determined areas between the transformed geospatial curve 502 and the segments of each of the model curves 404, the particular model curve segment 402 that yields the minimal area among may be determined. The location and the orientation that correspond to the particular model curve segment 402 may be identified as the location and the orientation of the real-world camera that captured the photograph from which the transformed geospatial curve 502 is based. In a further use case, a gradient-based search on the identified location and the identified orientation may be performed to determine the location and orientation of the camera more precisely. In this way, among other benefits, system 100 may determine location information, orientation information, or other information associated with photographs, videos, or other media items without necessarily relying on the availability of large collections of media items that have previously been tagged with location information, orientation information, etc.

In certain implementations, curve generation module 106 may generate one or more model curves based on modeling information associated with one or more locations. Curve transformation module 108 may transform the one or more model curves based on one or more criteria. The one or more criteria may include a width of a geospatial curve associated with a geographic media item, an angular size associated with a measuring unit of the one or more model curves, a focal length associated with the geographic media item, or other criteria. Comparison module 110 may be configured to compare a non-polygonal geospatial curve associated with a geographic media item with one or more segments of the one or more transformed model curves. Location module 112 may be configured to determine location information associated with the geographic media item based on the comparison of the non-polygonal geospatial curve with the one or more segments.

In some implementations, comparison module 110 may be configured such that the comparison of the non-polygonal geospatial curve with the one or more segments of the one or more transformed model curves may comprise determining one or more areas between the geospatial curve and the one or more segments. In one or more implementations, the determination of the one or more areas may comprise rotating, shifting, or a combination thereof the non-polygonal geospatial curve, the one or more segments, or a combination thereof. The determination of the location information associated with the geographic media item by location module 112 may be based on the one or more determined areas.

Server(s) 102, client computing platforms 104, external resources 114, and/or other components may be operatively linked via one or more electronic communication links. For example, such electronic communication links may be established, at least in part, via a network 116 such as the Internet and/or other networks. It will be appreciated that this is not intended to be limiting, and that the scope of this disclosure includes implementations in which server(s) 102, client computing platforms 104, external resources 114, and/or other components may be operatively linked via some other communication media.

A given client computing platform 104 may include one or more processors configured to execute computer program modules. The computer program modules may be configured to enable an expert or user associated with client computing platform 104 to interface with system 100 and/or external resources 114, and/or provide other functionality attributed herein to client computing platforms 104. By way of non-limiting example, client computing platform 104 may include one or more of a desktop computer, a laptop computer, a handheld computer, a netbook, a smartphone, a gaming console, and/or other computing platforms.

External resources 114 may include sources of information, hosts and/or providers of virtual spaces outside of system 100, external entities participating with system 100, and/or other resources. In some implementations, some or all of the functionality attributed herein to external resources 114 may be provided by resources included in system 100.

In some implementations, server(s) 102 may include an electronic storage 118, one or more processor(s) 120, and/or other components. Server(s) 102 may include communication lines, or ports to enable the exchange of information with network 116 and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 118 may comprise non-transitory storage media that electronically stores information. The electronic storage media of electronic storage 118 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 118 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 118 may include one or more virtual storage resources (e.g., cloud storage, a virtual private network, and/or other virtual storage resources). Electronic storage 118 may store software algorithms, information determined by processor(s) 120, information received from server(s) 102, information received from client computing platforms 104, and/or other information that enables server(s) 102 to function as described herein.

Processor(s) 120 is configured to provide information processing capabilities in server(s) 102. As such, processor(s) 120 may include one or more of a digital processor, an analog processor, a digital circuit designed to process information, an analog circuit designed to process information, a state machine, and/or other mechanisms for electronically processing information. Although processor(s) 120 is shown in FIG. 1 as a single entity, this is for illustrative purposes only. In some implementations, processor(s) 120 may include a plurality of processing units. These processing units may be physically located within the same device, or processor(s) 120 may represent processing functionality of a plurality of devices operating in coordination. Processor(s) 120 may be configured to execute modules 106, 108, 110, 112, and/or other modules. Processor(s) 120 may be configured to execute modules 106, 108, 110, 112, and/or other modules by software; hardware; firmware; some combination of software, hardware, and/or firmware; and/or other mechanisms for configuring processing capabilities on processor(s) 120. As noted, in certain implementations, a given client computing platform 104 may include one or more computer program modules that is the same as or similar to the computer program modules of server(s) 102. Client computing platform 104 may include one or more processors that are the same or similar to processor(s) 120 of server(s) 102 to execute such computer program modules of client computing platform 104.

It should be appreciated that although modules 106, 108, 110, and 112 are illustrated in FIG. 1 as being co-located within a single processing unit, in implementations in which processor(s) 120 includes multiple processing units, one or more of modules 106, 108, 110, and/or 112 may be located remotely from the other modules. The description of the functionality provided by the different modules 106, 108, 110, and/or 112 described below is for illustrative purposes, and is not intended to be limiting, as any of modules 106, 108, 110, and/or 112 may provide more or less functionality than is described. For example, one or more of modules 106, 108, 110, and/or 112 may be eliminated, and some or all of its functionality may be provided by other ones of modules 106, 108, 110, and/or 112. As another example, processor(s) 120 may be configured to execute one or more additional modules that may perform some or all of the functionality attributed below to one of modules 106, 108, 110, and/or 112.

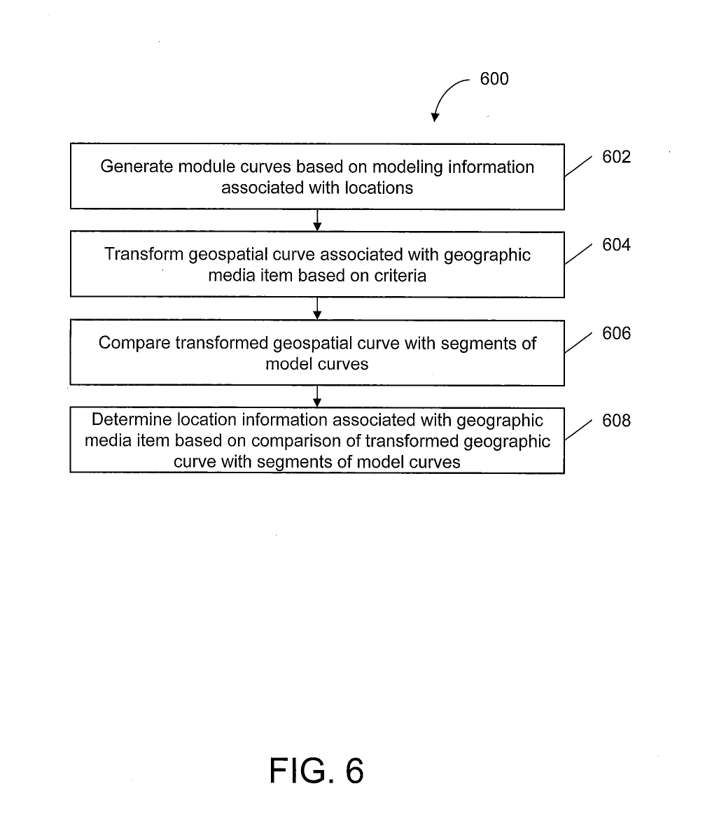

FIG. 6 illustrates a method of facilitating geospatial-curve-based geolocation of media items, in accordance with one or more implementations. The operations of method 600 presented below are intended to be illustrative. In some implementations, method 600 may be accomplished with one or more additional operations not described, and/or without one or more of the operations discussed. Additionally, the order in which the operations of method 600 are illustrated in FIG. 6 and described below is not intended to be limiting.

In some implementations, method 600 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 600 in response to instructions stored electronically on an electronic storage medium. The one or more processing devices may include one or more devices configured through hardware, firmware, and/or software to be specifically designed for execution of one or more of the operations of method 600.

At an operation 602, one or more model curves may be generated based on modeling information associated with one or more locations. In certain implementations, the modeling information may include elevation information, boundary information, or other information associated with the one or more locations. The geospatial curve may include a horizon curve associated with the geographic media item or other geospatial curve associated with the geographic media item. In some implementations, points associated with the modeling information may be projected onto one or more cylindrical image planes to generate the one or more model curves. Operation 602 may be performed by a curve generation module that is the same as or similar to curve generation module 106, in accordance with one or more implementations.

At an operation 604, a geospatial curve associated with a geographic media item may be transformed based on one or more criteria. In some implementations, the one or more criteria may include a width of the geospatial curve, an angular size associated with a measuring unit of the one or more model curves, a focal length associated with the geographic media item, or other criteria. Operation 604 may be performed by a curve transformation module that is the same as or similar to curve transformation module 108, in accordance with one or more implementations.

At an operation 606, the transformed geospatial curve may be compared with one or more segments of the one or more model curves. In certain implementations, the one or more model curves may include one or more panoramic model curves corresponding to one or more 360-degree views. In some implementations, the one or more segments of the one or more model curves may correspond to one or more less-than-360-degree portions of the one or more 360-degree views. The geospatial curve may correspond to a less-than-360-degree view. Operation 606 may be performed by a comparison module that is the same as or similar to comparison module 110, in accordance with one or more implementations.

At an operation 608, location information associated with the geographic media item may be determined based on the comparison of the transformed geospatial curve with the one or more segments of the one or more model curves. Operation 608 may be performed by a location module that is the same as or similar to location module 112, in accordance with one or more implementations.

In certain implementations, with respect to operations 606 and 608, one or more areas between the transformed geospatial curve and the one or more segments of the one or more model curves may be determined during the comparison of the transformed geospatial curve with the one or more segments. The location information associated with the geographic media item may be determined is based on the one or more areas.

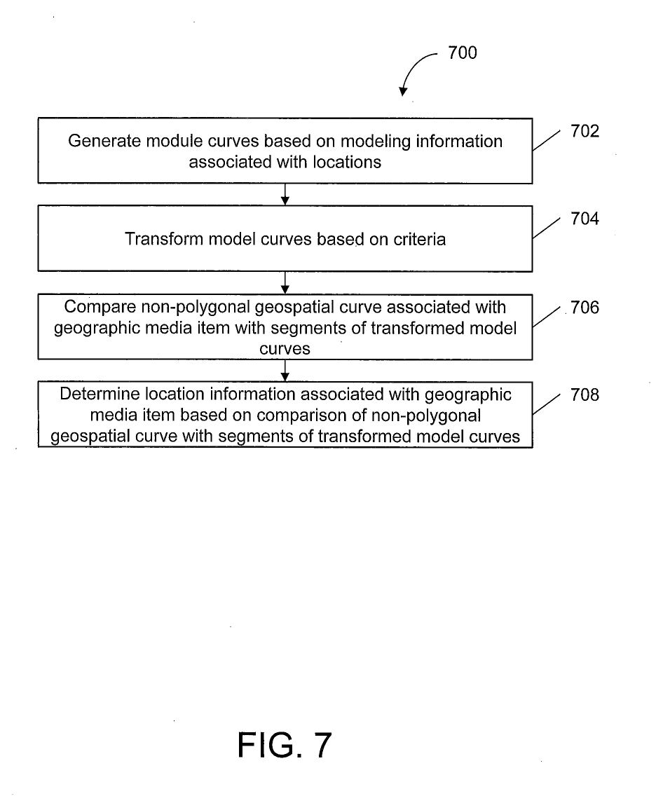

FIG. 7 illustrates a method of facilitating geospatial-curve-based geolocation of media items, in accordance with one or more implementations. The operations of method 700 presented below are intended to be illustrative. In some implementations, method 700 may be accomplished with one or more additional operations not described, and/or without one or more of the operations discussed. Additionally, the order in which the operations of method 700 are illustrated in FIG. 7 and described below is not intended to be limiting.

In some implementations, method 700 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 700 in response to instructions stored electronically on an electronic storage medium. The one or more processing devices may include one or more devices configured through hardware, firmware, and/or software to be specifically designed for execution of one or more of the operations of method 700.

At an operation 702, one or more model curves may be generated based on modeling information associated with one or more locations. In certain implementations, the modeling information may include elevation information, boundary information, or other information associated with the one or more locations. The geospatial curve may include a horizon curve associated with the geographic media item or other geospatial curve associated with the geographic media item. In some implementations, points associated with the modeling information may be projected onto one or more cylindrical image planes to generate the one or more model curves. Operation 702 may be performed by a curve generation module that is the same as or similar to curve generation module 106, in accordance with one or more implementations.

At an operation 704, the one or more model curves may be transformed based on one or more criteria. In some implementations, the one or more criteria may include a width of a geospatial curve associated with a geographic media item, an angular size associated with a measuring unit of the one or more model curves, a focal length associated with the geographic media item, or other criteria. Operation 704 may be performed by a curve transformation module that is the same as or similar to curve transformation module 108, in accordance with one or more implementations.

At an operation 706, a non-polygonal geospatial curve associated with a geographic media item may be compared with one or more segments of the one or more transformed model curves. In certain implementations, the one or more model curves may include one or more panoramic model curves corresponding to one or more 360-degree views. In some implementations, the one or more segments of the one or more transformed model curves may correspond to one or more less-than-360-degree portions of the one or more 360-degree views. The geospatial curve may correspond to a less-than-360-degree view. Operation 706 may be performed by a comparison module that is the same as or similar to comparison module 110, in accordance with one or more implementations.

At an operation 708, location information associated with the geographic media item may be determined based on the comparison of the non-polygonal geospatial curve with the one or more segments of the one or more transformed model curves. Operation 708 may be performed by a location module that is the same as or similar to location module 112, in accordance with one or more implementations.

In certain implementations, with respect to operations 706 and 708, one or more areas between the geospatial curve and the one or more segments of the one or more transformed model curves may be determined during the comparison of the non-polygonal geospatial curve with the one or more segments. The location information associated with the geographic media item may be determined is based on the one or more areas.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A computer-implemented method of facilitating geospatial-curve-based geolocation of media items, the method being implemented by a computer system that includes one or more physical processors, the method comprising:
generating, by a curve generation module, one or more model curves based on modeling information associated with one or more locations;
transforming, by a curve transformation, a geospatial curve associated with a geographic media item based on one or more criteria, wherein the transformed geospatial curve is a non-polygonal geospatial curve;
comparing, by a comparison module, the transformed geospatial curve with one or more segments of the one or more model curves; and
determining, by a location module, location information associated with the geographic media item based on the comparison of the transformed geospatial curve with the one or more segments.

2. The method of claim 1, wherein the one or more criteria includes a width of the geospatial curve.

3. The method of claim 1, wherein the one or more criteria includes an angular size associated with a measuring unit of the one or more model curves.

4. The method of claim 1, wherein the one or more criteria, includes a focal length associated with the geographic media item.

5. The method of claim 1, wherein the one or more model curves includes one or more panoramic model curves corresponding to one or more 360-degree views, and wherein the one or more segments correspond to one or more less-than-360-degree portions of the one or more 360-degree views, and the geospatial curve corresponds to a less-than-360-degree view.

6. The method of claim 1, further comprising:
determining, by the comparison module, one or more areas between the transformed geospatial curve and the one or more segments during the comparison of the transformed geospatial curve with the one or more segments, wherein the determination of the location information associated with the geographic media item is based on the one or more areas.

7. The method of claim 1, wherein determining the one or more areas comprises rotating, shifting, or a combination thereof the transformed geospatial curve, the one or more segments of the one or more model curves, or a combination thereof.

8. The method of claim 1, wherein the modeling information includes elevation information, boundary information, or a combination thereof associated with the one or more locations.

9. The method of claim 1, wherein the geospatial curve includes a horizon curve associated with the geographic media item.

10. The method of claim 1, further comprising:
projecting, by the curve generation module, points associated with the modeling information onto one or more cylindrical image planes, wherein the generation of the one or more model curves is based on the projected points.

11. A system for facilitating geospatial-curve-based geolocation of media items, the system comprising:
one or more physical processors configured to execute one or more computer program modules, the computer program modules comprising:
a curve generation module configured to generate one or more model curves based on modeling information associated with one or more locations;
a curve transformation module configured to transform a geospatial curve associated with a geographic media item based on one or more criteria, wherein the transformed geospatial curve is a non-polygonal geospatial curve;
a comparison module configured to compare the transformed geospatial curve with one or more segments of the one or more model curves; and
a location module configured to determine location information associated with the geographic media item based on the comparison of the transformed geospatial curve with the one or more segments.

12. The system of claim 11, wherein the one or more criteria includes a width of the geospatial curve, an angular size associated with a measuring unit of the one or more model curves, a focal length associated with the geographic media item, or a combination thereof.

13. The system of claim 11, wherein the one or more model curves includes one or more panoramic model curves corresponding to one or more 360-degree views, and wherein the one or more segments correspond to one or more less-than-360-degree portions of the one or more 360-degree views, and the geospatial curve corresponds to a less-than-360-degree view.

14. The system of claim 11, wherein the comparison module is further configured to determine one or more areas between the transformed geospatial curve and the one or more segments during the comparison of the transformed geospatial curve with the one or more segments, and wherein the determination of the location information associated with the geographic media item is based on the one or more areas.

15. The system of claim 11, wherein the modeling information includes elevation information, boundary information, or a combination thereof associated with the one or more locations.

16. The system of claim 11, wherein the geospatial curve includes a horizon curve associated with the geographic media item.

17. The system of claim 11, wherein the curve generation module is further configured to project points associated with the modeling information onto one or more cylindrical image planes, and wherein the generation of the one or more model curves is based on the projected points.

18. A method of facilitating geospatial-curve-based geolocation of media items, the method being implemented by a computer system that includes one or more physical processors, the method comprising:
generating, by a curve generation module, one or more model curves based on modeling information associated with one or more locations;
transforming, by a curve transformation module, the one or more model curves based on one or more criteria;
comparing, by a comparison module, a non-polygonal geospatial curve associated with a geographic media item with one or more segments of the one or more transformed model curves; and
determining, by a location module, location information associated with the geographic media item based on the comparison of the non-polygonal geospatial curve with the one or more segments.

19. The method of claim 18, wherein the one or more criteria includes a width of the non-polygonal geospatial curve, an angular size associated with a measuring unit of the one or more model curves, a focal length associated with the geographic media item, or a combination thereof.

20. The method of claim 18, wherein the one or more model curves includes one or more panoramic model curves corresponding to one or more 360-degree views, and wherein the one or more segments correspond to one or more less-than-360-degree portions of the one or more 360-degree views, and the non-polygonal geospatial curve corresponds to a less-than-360-degree view.
